(19) United States
(12) Patent Application Publication
(10) Pub. No.: US 2018/0039355 A1
(43) Pub. Date: Feb. 8, 2018

(54) TOUCH ASSISTING STRUCTURE AND DEVICE THEREOF

(71) Applicants: JUNG-CHING HSU, NEW TAIPEI CITY (TW); CHIN-TU WU, NEW TAIPEI CITY (TW); SHENG-CHIA CHEN, NEW TAIPEI CITY (TW)

(72) Inventors: JUNG-CHING HSU, NEW TAIPEI CITY (TW); CHIN-TU WU, NEW TAIPEI CITY (TW); SHENG-CHIA CHEN, NEW TAIPEI CITY (TW)

(21) Appl. No.: 15/657,233

(22) Filed: Jul. 24, 2017

(30) Foreign Application Priority Data
Aug. 2, 2016 (TW) 105124436

(51) Int. Cl. G06F 3/044; G02F 1/1333; G06F 1/16

(52) U.S. Cl. CPC G06F 3/044; G06F 1/1607; G02F 1/133305; G02F 1/13338

(57) ABSTRACT

In a touch assisting structure and its device, the touch assisting structure is integrated with a projected capacitive touch device to achieve the effect of telecommunicatively triggering an action by a touch control after any insulator or non-insulator is touched actively or passively, and the structure and device may be applied to any moving object or a robot with a touch function. The touch assisting structure includes a main body and an electrically conductive medium, and the main body is a flexible body in a solid state, and the solid main body produces a deformation after the solid main body is compressed by a force and resumes its original solid state after the force is released. The electrically conductive medium is uniformly distributed in the main body and has a conductivity greater than 0.5 S·m−1.

### CROSS-REFERENCE TO RELATED APPLICATIONS

This non-provisional application claims priority under 35 U.S.C. §119(a) on Patent Application No(s). 105124436 filed in Taiwan, R.O.C. on Aug. 2, 2016, the entire contents of which are hereby incorporated by reference.

### FIELD OF INVENTION

The present invention relates to the field of touch control, in particular to a touch assisting structure and a device of the touch assisting structure, which are capable of producing a touch trigger effect after any insulating or non-insulating touch source is touched actively or passively, so as to improve the convenience of use and even apply the touch assisting structure and device to the robot technology to achieve a touch electronic skin.

### BACKGROUND OF INVENTION

### 1. Description of the Related Art

Most conventional touch panels are applied in the area of screens, and generally operated passively by receiving a touch instruction externally inputted by a user through the user's finger or a touch pen. For example, smart phones and tablet PCs are operated in this way. In addition, the basic principle of touch control is mainly divided into inductive touch, resistive touch, capacitive touch and acoustic wave touch. Wherein, the acoustic wave touch determines whether or not to trigger an action by blocking or affecting the moving path of acoustic waves or infrared light. The capacitive touch can just use specific signal sources, so that the capacitive touch mechanism cannot be used an insulator as a touch source. Nevertheless, the acoustic wave touch has the disadvantage of being interfered easily by external environmental substances such as dust, oil, liquid, etc, and thus causing a wrong transmission of acoustic waves. Although the resistive touch requires simple technique and low entry, yet it has the disadvantages of low sensitivity and short life. Therefore, the capacitive touch is generally applied to most touch devices in different areas.

Compared with the resistive touch, the capacitive touch has the advantages of high scratch resistance, good antifouling property, and quick response, and its main principle is to detect a change of capacitance after a touch is detected and use such change of capacitance as a basis for determining whether or not to trigger an action. Further, the capacitive touch can be subdivided into surface capacitive touch and projected capacitive touch. Regardless of which touch mechanism, a touch source must be operated when a non-insulator approaches a contact point. For example, the use of a dry wooden rod, a plastic product, a thick glove theoretically cannot effectively trigger a capacitive touch device.

In our future life, various different types of devices come with the property of active movement, such as the devices applied for movement or a robot having a mechanical arm. If a touch device is installed to the robot, and a touch object is an insulator or a poor conductor, then the mechanical arm or the robot will be unable to make effective judgment for the trigger of a correct action. Therefore, present mechanical arms or robots such as a floor cleaning robot determine whether or not to approach or touch an object by near-field sensing or acoustic wave sensing.

However, the aforementioned touch property or mechanism still cannot achieve the anthropomorphic performance effectively, and the present invention does not focus on the safe disconnection before touch. On the other hand, the present invention focuses on the operation by using an insulator as a trigger source, and other applications emphasize on the anthropomorphic characteristics of the robots in future life, particular emphasize on the electronic skin having a touch function and covered onto the external surface of a robot.

In view of the drawbacks of the prior art, the inventor of the present invention based on years of experience in the related industry to conduct extensive research and development, and finally invented a touch assisting structure and its device to achieve the anthropomorphic robot technology and improve the convenience of use of various different touch devices.

### 2. Summary of the Invention

Therefore, it is a primary objective of the present invention to overcome the drawbacks of the prior art by providing a touch assisting structure and a device of the touch assisting structure, which are capable of producing a touch trigger effect after any insulating or non-insulating touch source is touched actively or passively.

To achieve the aforementioned and other objectives, the present invention provides a touch assisting structure, installed onto a surface of a projected capacitive touch device, and provided for triggering a telecommunication action after actively or passively touching any insulating or non-insulating touch source, comprising: a main body, being a flexible body in a solid state, and the solid main body producing a deformation after the solid main body is compressed by a force and resuming its original solid state after the force is released; and an electrically conductive medium, uniformly distributed in the main body and having a conductivity greater than 0.5 S·m−1.

In a preferred embodiment, the main body is made of a sheet with a non-uniform thickness, such that after the touch assisting structure is installed into a device, the touch purpose and contact differentiation of the device applied in different areas are taken into consideration.

In another preferred embodiment, the main body is made of a water-absorbent porous material to prevent any liquid electrically conductive medium from dispersing after the main body is compressed, and the touch assisting structure further comprises an insulating layer totally covered onto an external surface of the main body.

In a further preferred embodiment, the main body is made of a polymer with a polyisoprene content.

Further, the present invention further provides a touch assisting device based on the aforementioned touch assisting structure, and the touch assisting device comprises a projected capacitive touch device and a touch assisting structure. Wherein, the touch assisting structure is installed onto a surface of a projected capacitive touch device and comprises a main body and an electrically conductive medium. Wherein, the main body is a flexible body in a solid state, and the solid main body produces a deformation after the solid main body is compressed by a force and resumes its original solid state after the force is released; and an electrically conductive medium, uniformly distributed in the main body and having a conductivity greater than 0.5 S·m−1.

In a preferred embodiment, the touch assisting device further comprises a sensitivity adjusting module, telecommunicatively coupled to the projected capacitive touch device, and provided for setting a reference variance value, and determining whether or not to trigger an action after a touch signal is received and compared to check if there is a change of capacitance of the projected capacitive touch device, so as to define each triggered action.

In another preferred embodiment, the projection capacitive touch device has a displacement detecting module, and when the touch signals are received continuously, the displacement detecting module detects the amount of displacement of the projection capacitive touch device with respect to the touch source.

In a further preferred embodiment, the projection capacitive touch device has a pressure detecting module, and when the touch signal is received, the pressure detecting module detects the magnitude of a touch pressure of the touch source with respect to the projection capacitive touch device.

Further, the present invention provides a robot with a touch feedback based on the aforementioned touch assisting structure and touch assisting device, and the robot comprises a robot body and the aforementioned touch assisting device. Wherein, the robot body has an electronic skin layer, and the touch assisting device is installed onto the electronic skin layer to produce an anthropomorphic robot with touch response.

In the touch assisting structure and its device of the present invention, the touch assisting structure is integrated with a projected capacitive touch device to achieve the effect of telecommunicatively triggering an action by a touch control after any insulator or non-insulator is touched actively or passively, and the present invention may be applied to an fixed or moving object to improve the convenience of the touch control and provide an electronic skin with a touch function for the anthropomorphic robot technology.

### BRIEF DESCRIPTION OF THE DRAWINGS

FIG. 1A is a first schematic view of a touch assisting structure and its action in accordance with a preferred embodiment of the present invention;

FIG. 1B is a second schematic view of a touch assisting structure and its action in accordance with a preferred embodiment of the present invention;

FIG. 1C is a third schematic view of a touch assisting structure and its action in accordance with a preferred embodiment of the present invention;

FIG. 2 is a schematic view showing the touch principle in accordance with a preferred embodiment of the present invention;

FIG. 3A is a first schematic view of a touch assisting structure with a change of appearance in accordance with the present invention;

FIG. 3B is a second schematic view of a touch assisting structure with a change of appearance in accordance with the present invention;

FIG. 4 is a third schematic view of a touch assisting structure with a change of appearance in accordance with the present invention;

FIG. 5A is a first block diagram of a touch assisting device in accordance with a preferred embodiment of the present invention;

FIG. 5B is a second block diagram of a touch assisting device in accordance with a preferred embodiment of the present invention; and

FIG. 6 is a schematic view of a robot having a touch feedback in accordance with the present invention.

### DESCRIPTION OF THE PREFERRED EMBODIMENTS

The above and other objects, features and advantages of this disclosure will become apparent from the following detailed description taken with the accompanying drawings.

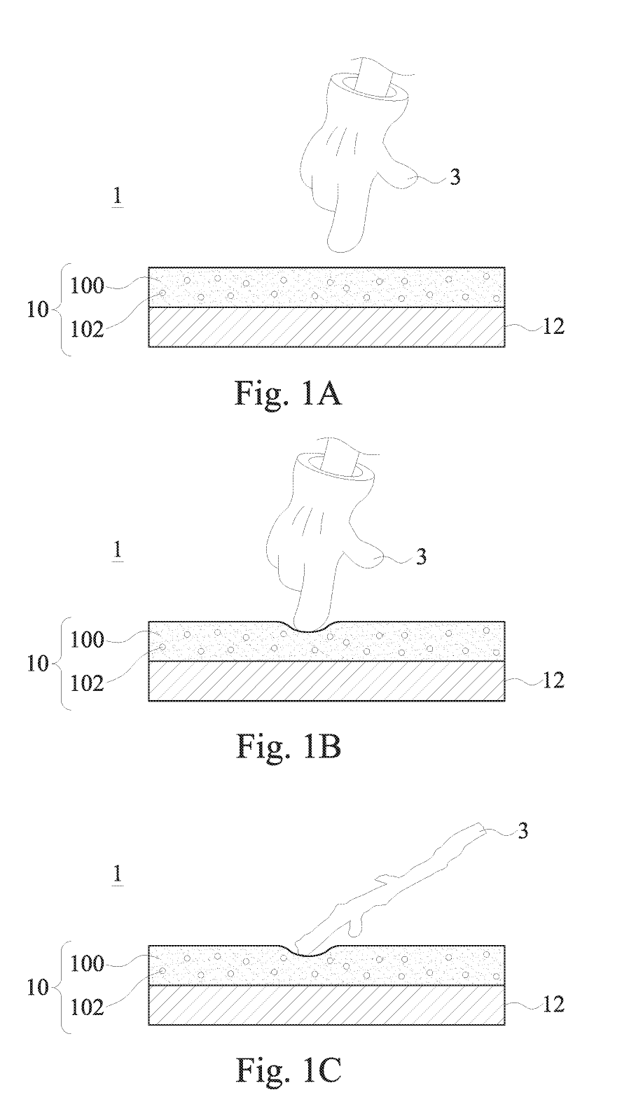

With reference to FIGS. 1A˜1C and 2 for the first to third schematic views of a touch assisting structure and a schematic view showing the principle of the touch control of the touch assisting structure in accordance with a preferred embodiment of the present invention respectively, the touch assisting structure 10 comprises a main body 100 and an electrically conductive medium 102, and the touch assisting structure 10 is installed onto a surface of a projected capacitive touch device 12 to form a touch assisting device 1. Due to the limitation of the operating principle of the conventional projected capacitive touch device 12, an external touch source 3 must be a non-insulator before an action can be triggered. However, the touch assisting structure 10 of the present invention is installed on a side of the projected capacitive touch device 12, and any an insulating or non-insulating touch source 3 such as a plastic member, a branch or any solid object can be used to touch the touch assisting structure 10 of the touch assisting device 1 of the present invention for the trigger control action. In addition, either the active touch or the passive touch will not affect its determination. In FIGS. 1A and 1B, the main body 100 is made of a flexible material, and the main body 100 is in a fixed solid state when no force is exerted onto the main body 100. After an external touch source 3 is touched actively or passively, the main body 100 is compressed by the force and the solid state produces a deformation, and after the external force is released, the main body 100 immediately resumes its original solid state. For example, the touch assisting structure is not compressed by a force as shown in FIG. 1A and it is compressed by a force as shown in FIG. 1B.

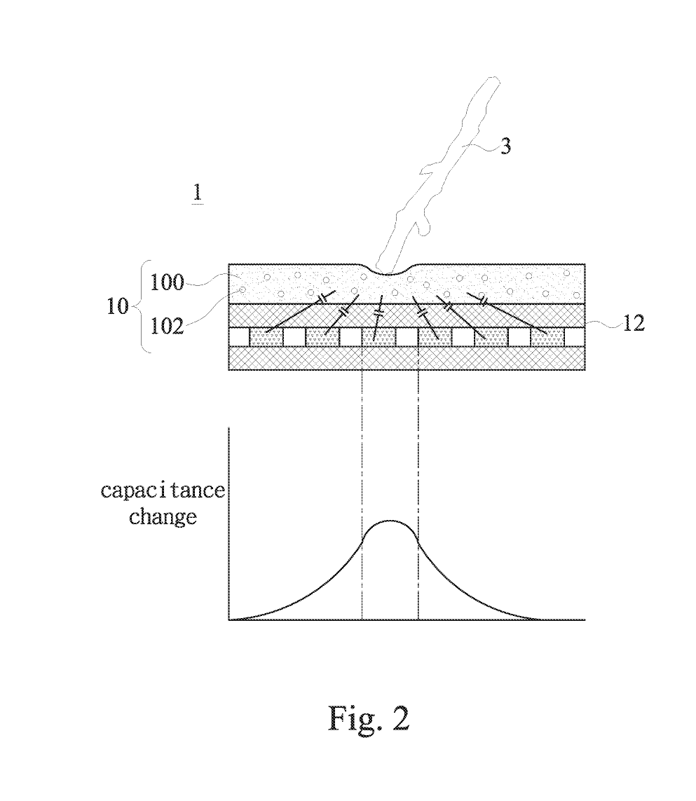

With reference to FIG. 2, the touch assisting structure 10 is stacked onto a surface of the projected capacitive touch device 12, and a touch control force is exerted onto the touch source 3, so that the main body 100 produces a deformation, and the main body 100 has the electrically conductive medium 102 uniformly distributed thereon and having a conductivity greater than 0.5 S·m−1. Therefore, the change of mutually sensed capacitance can be read and determined more easily, and the deformed main body 100 may cause a change of spatial distribution of the electrically conductive medium 102 with respect the capacitive touch device 12. Even though there is a change of sensed capacitance, the change of capacitance can be used to define a touch trigger action. With such principle, the touch source 3 such as a finger in a thick glove as shown in FIG. 1B or even a branch as shown in FIG. 1C can be touched actively or passively to achieve the touch trigger action effectively.

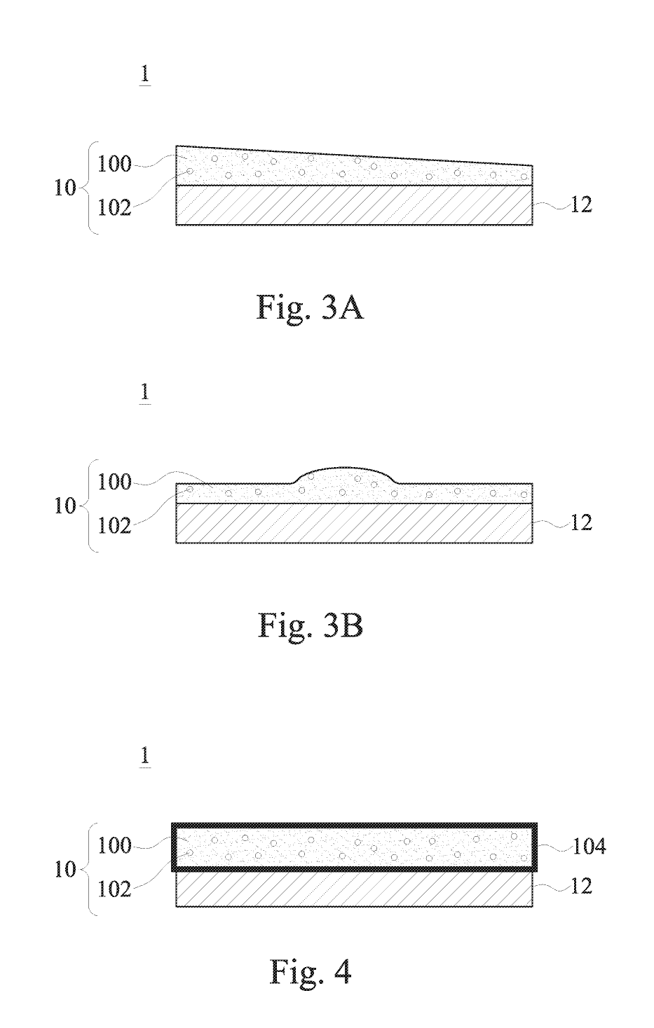

With reference to FIGS. 3A, 3B and 4 for the first to third schematic views of a touch assisting structure with a change of appearance in accordance with the present invention respectively, after the touch assisting device 1 actively or passively touches an insulating or non-insulating touch source 3, the touch assisting device 1 still can trigger a telecommunication action and its scope of applicability becomes broader. For example, the touch assisting device 1 may be installed at a finger or a palm of a mechanical arm, and the purposes for its contact are different, so that the main body 100 with different thicknesses resulting in different movement sensitivities and responses may be used to achieve a layout with the concept of an electronic skin. With the change of the main body 100 as shown in FIG. 3A or 3B, the main body 100 may be a sheet with a non-uniform thickness to fulfill different requirements such as the limitation of installation space or the sensitivity of movement. Theoretically, the main body 100 is cut into smaller volume units to fit an installation better. However, the smaller units may cause electromagnetic interference with each other more easily, and a correct determination of the touch action will be affected. Therefore, the main body 100 designed as an integral structure with a change of different thicknesses can reduce the occurrence of wrong actions. Such arrangement is also more cost-effective and convenient to manufacturing process, subsequent installation and telecommunication control.

Further, the present invention is operated according to the operating principle as shown in FIG. 2. Therefore, it is necessary for the touch assisting structure 10 to have the main body 100 and the electrically conductive medium 102 with a conductivity greater than 0.5 S·m−1. As to the choice of materials, the main body 100 may be made of a water-absorbent porous material such as a sponge material. Now, a liquid of an electrolyte may be adsorbed into the water-absorbent porous material to serve as the touch assisting structure 10. Further, an insulating layer 104 may be coated or covered onto an external surface of the water-absorbent porous material to provide a more stable touch assisting structure 10, and the insulating layer 104 may be a general plastic film material. Of course, the main body 100 may be made of a polymer with a polyisoprene content. Since the structure is more stable and the electrically conductive medium 102 is doped into the main body 100, therefore even if a force is applied to the main body 100 to deform the main body 100, the main body 100 will recover its original solid state without affecting the original distribution of the electrically conductive medium 102 after the external force is released.

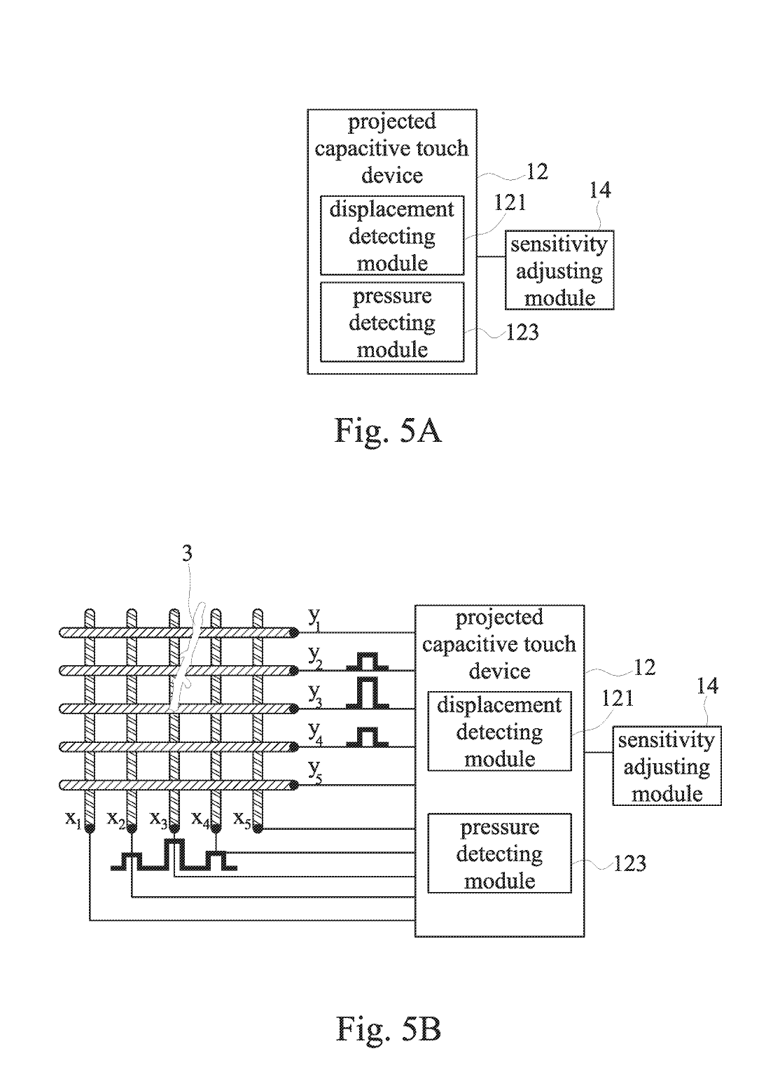

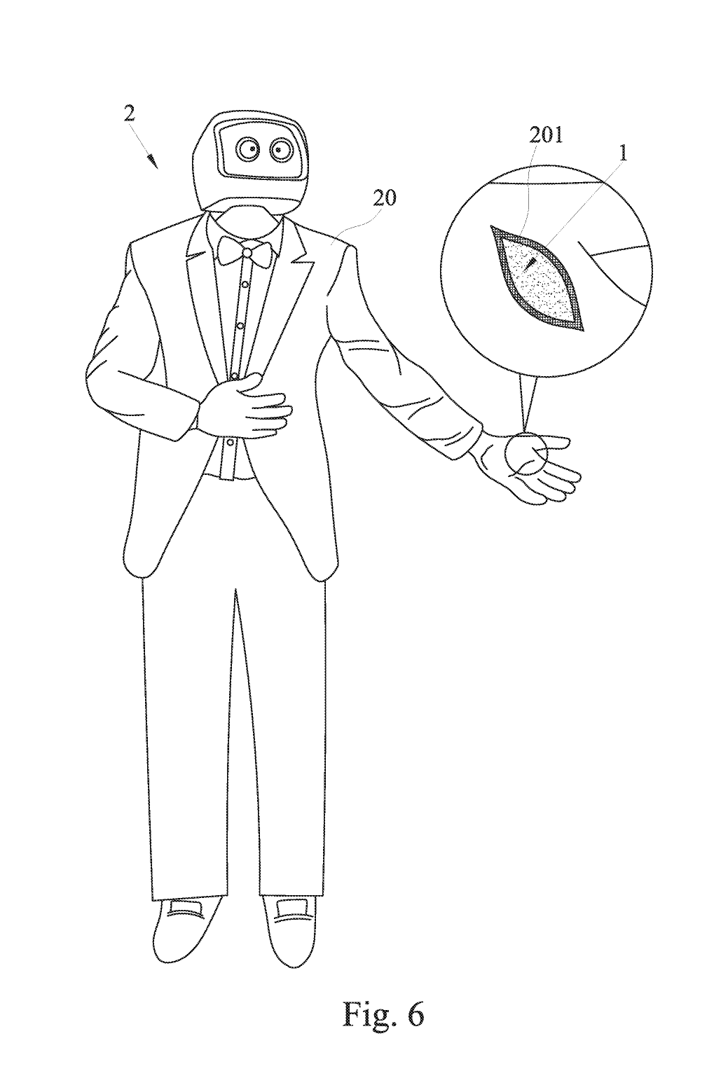

With reference to FIGS. 5A and 5B for the first and second block diagrams of a touch assisting device in accordance with a preferred embodiment of the present invention respectively, the present invention has a broad scope of applicability, so that the detailed touch control effect and adjustment can be made according to the required application. To adjust the sensitivity of sensing the capacitance or prevent identifying a wrong action, the touch assisting device 1 further comprises a sensitivity adjusting module 14 for setting a reference variance value. The sensitivity adjusting module 14 is telecommunicatively coupled to the projected capacitive touch device 12, so that after a touch signal is received and compared with the change of capacitance of the projected capacitive touch device 12, various trigger actions may be defined. For example, the most basic comparison method may be used for comparing the change of capacitance and determining whether the change of capacitance is greater than the reference variance value. To take the diversity of actions triggered by a touch into consideration, the touch assisting device 1 of the present invention further comprises a displacement detecting module 121, such that when the touch signals are received continuously, the displacement detecting module 121 may detect the amount of displacement of the projected capacitive touch device 12 with respect to the touch source 3 and record and determine the touch track and path or even define its action determination. Further, the projected capacitive touch device 12 may have a pressure detecting module 123, such that when the touch signal is received, the pressure detecting module 123 detects the magnitude of a touch pressure of the touch source 3 with respect to the projected capacitive touch device 12. For example, when the invention is implemented in a robotic arm, the magnitude of the pressure of the mechanical arm touching the touch source 3 is detected to determine a preferred force that should be applied by the mechanical arm, so that a high-precision object may be moved by the mechanical arm, or any recreational and auxiliary mechanical arm may be used in different environmental conditions.

With reference to FIG. 6 for a schematic view of a robot with a touch feedback in accordance with the present invention, the robot 2 comprises a robot body 20 and the aforementioned touch assisting device 1. The robot body 20 has an electronic skin layer 201, so that the robot 2 has a human-like skin, and the touch assisting device 1 is installed in the electronic skin layer 201. With reference to FIG. 6 for the blowup view of a cut skin, the relation between the installed components is shown. After the robot 1 actively touches any touch source 3, the touch assisting device 1 of the present invention detects the touch condition, and the robot 2 has a human-like response. In the future, any position of the robot 2 such as the finger, palm, body, foot, or head may have a sensing device of the present invention to achieve the effect of feeding back a touch information after any object is touched actively or passively and providing the touch information to the robot 2 for determination, and the robot 2 can be used conveniently in various different areas.

To overcome the drawbacks of the touch control of the prior art, the present invention provides a touch assisting structure and device, so that the touch source is no longer limited. More importantly, the conventional way of passively controlling the touch device can be changed and expanded to the way of actively touching any object or performing a human-like response after the touch is determined. For example, the touch position, track, displacement, or force may be detected, and different touch positions may be computed differently before a response is made, so that the touch assisting structure and device of the invention may be applied to robotic technology to improve the convenience and feasibility of future life significantly.

While the invention has been described by means of specific embodiments, numerous modifications and variations could be made thereto by those skilled in the art without departing from the scope and spirit of the invention set forth in the claims.

What is claimed is:

1. A touch assisting structure, installed onto a surface of a projected capacitive touch device, and provided for triggering a telecommunication action after actively or passively touching any insulating or non-insulating touch source, comprising:
a main body, being a flexible body in a solid state, and the solid main body producing a deformation after the solid main body is compressed by a force and resuming its original solid state after the force is released; and
an electrically conductive medium, uniformly distributed in the main body and having a conductivity greater than 0.5 S·m−1.

2. The touch assisting structure of claim 1, wherein the main body is made of a sheet with a non-uniform thickness.

3. The touch assisting structure of any one of claims and 1, wherein the main body is made of a water-absorbent porous material.

4. The touch assisting structure of any one of claims and 2, wherein the main body is made of a water-absorbent porous material.

5. The touch assisting structure of claim 3, further comprising an insulating layer totally covered onto an external surface of the main body.

6. The touch assisting structure of claim 4, further comprising an insulating layer totally covered onto an external surface of the main body.

7. The touch assisting structure of any one of claims and 1, wherein the main body is made of a polymer with a polyisoprene content.

8. The touch assisting structure of any one of claims and 2, wherein the main body is made of a polymer with a polyisoprene content.

9. A touch assisting device, comprising:
a projected capacitive touch device; and
a touch assisting structure, installed onto a surface of a projected capacitive touch device, comprising:
a main body, being a flexible body in a solid state, and the solid main body producing a deformation after the solid main body is compressed by a force and resuming its original solid state after the force is released, and
an electrically conductive medium, uniformly distributed in the main body and having a conductivity greater than 0.5 S·m−1.

10. The touch assisting device of claim 9, further comprising: a sensitivity adjusting module, telecommunicatively coupled to the projected capacitive touch device, and provided for setting a reference variance value, and determining whether or not to trigger an action after a touch signal is received and compared to check if there is a change of capacitance of the projected capacitive touch device greater than the reference variance value.

11. The touch assisting device of claim 10, wherein the projected capacitive touch device has a displacement detecting module, and when the touch signals are received continuously, the displacement detecting module detects the amount of displacement of the projected capacitive touch device with respect to the touch source.

12. The touch assisting device of claim 11, wherein the projected capacitive touch device has a pressure detecting module, and when the touch signal is received, the pressure detecting module detects the magnitude of a touch pressure of the touch source with respect to the projected capacitive touch device.
